(19) United States
(12) Patent Application Publication
(10) Pub. No.: US 2009/0040207 A1
(43) Pub. Date: Feb. 12, 2009

(54) DISPLAY DEVICE AND DRIVING METHOD THEREOF

(76) Inventors: Kyong-Tae PARK, Suwon-si (KR); Alexander Arkhipov, Suwon-si (KR)

Correspondence Address: MACPHERSON KWOK CHEN & HEID LLP, 2033 GATEWAY PLACE, SUITE 400, SAN JOSE, CA, 95110, US

(21) Appl. No.: 11/852,033

(22) Filed: Sep. 7, 2007

(30) Foreign Application Priority Data
Aug. 6, 2007 (KR) 10-2007-0078615

(51) Int. Cl. G09G 5/00; G09G 3/32

(52) U.S. Cl. 345/211; 345/204; 345/83

(57) ABSTRACT

A display device includes: a plurality of pixels that represent a first color, a second color, a third color, and white; a signal processor that converts input image signals respective to the colors into output image signals respective to the colors plus an output image signal for the white color, calculates a current consumption amount consumed in the pixels based on the output image signals, and compensates the output image signals in accordance with the current consumption amount; and a data driver that converts the output image signals into data voltages and supplies the data voltages to the pixels.

### CROSS-REFERENCE TO RELATED APPLICATION

This application claims priority to and the benefit of Korean Patent Application No. 10-2007-0078615 filed in the Korean Intellectual Property Office on Aug. 6, 2007, the entire contents of which are incorporated herein by reference.

### BACKGROUND OF THE INVENTION

1. Field of the Invention

The present invention relates to a display device and, in particular, to a multi-color organic light emitting device having a plurality of pixels, each of which represents four-colors or more, and a driving method therefor.

2. Description of the Related Art

Flat panel displays that can replace cathode ray tubes include a plurality of pixels arranged in a matrix form respectively representing each of three primary colors. One color is determined by combining the three primary colors emitting from three pixels, and the flat panel displays can display desired images by appropriately controlling the luminance of each pixel.

However, when an image is displayed with only three pixels for the three primary colors, light efficiency may be adversely affected. Particularly, in organic light emitting devices (OLEDs), the light emitting efficiency of an emission layer may be further reduced as the material of the emission layer of the organic light emitting diode changes with color. Accordingly, it has been suggested that a white pixel emitting white light be added in addition to the three primary color pixels.

Such a four color display device having white pixels and the three primary color pixels receives input image signals for the three primary color pixels, for example three pixels (red, green, and blue pixels) for red, green, and blue colors, to generate output image signals for the red, green, blue, and white pixels. However, such OLEDs result in increased current consumption.

### SUMMARY OF THE INVENTION

According to an embodiment of the present invention, a display device is provided that includes a plurality of pixels, a signal processor, and a data driver. The plurality of pixels respectively represent a first color, a second color, a third color, and white. The signal processor converts three input image signals (referred to as first, second, and third input image signals) respective to the first, second, and third colors into three output image signals (referred to as first, second, and third output image signals) respective to the first, second, and third colors plus an output signal (referred to as a white output image signal) for the white color, calculates a current consumption amount consumed in the pixels based on the first, second, third, and white output image signals, and compensates the first, second, third, and white output image signals in accordance with the current consumption amount. The data driver converts the white output image signal and the first to third output image signals into data voltages and supplies the data voltages to the pixels.

The signal processor may include a scaling unit, an RGBW converter, and a constant determiner. The scaling unit changes a magnitude of the first, second, and third input image signals based on a current change constant to generate first, second, and third conversion image signals. The RGBW converter generates the first, second, third, and white output image signals from the first, second, and third conversion image signals based on a luminance compensation constant. The constant determiner defines the current change constant from the current consumption amount and defines the luminance compensation constant from the current consumption amount and a total number defined by counting luminances of the first, second, third, and white output image signals exceeding a threshold in one frame.

The constant determiner may: determine whether the current consumption amount is within a predetermined range; output a previous current change constant and a previous luminance compensation constant as a new current change constant and a new luminance compensation constant when the current consumption amount is within the predetermined range; and change at least one of the previous current change constant and the previous luminance compensation constant to output such as the new current change constant and the new luminance compensation constant when the current consumption amount is out of the predetermined range.

The predetermined range of the current consumption amount may be about 10% to about 35% of a maximum current amount.

Alternatively, the predetermined range of the current consumption amount may be about 15% to about 30% of a maximum current amount.

The RGBW converter may generate the white output image signal and the first, second, and third output image signals based on the first, second, and third input image signals and the luminance compensation constant.

The RGBW converter may include a gamma converter, a calculator, a clipping unit, a three color de-gamma converter, and a white de-gamma converter. The gamma converter gamma-converts the generated first, second, and third input image signals to generate first, second, and third luminance signals, respectively. The calculator generates a white luminance signal using the luminance compensation constant and the first, second, and third luminance signals, and converts the first, second, and third luminance signals into first, second, and third compensation luminance signals L1′, L2′, and L3′, respectively. The clipping unit respectively compares the first, second, and third compensation luminance signals and the threshold luminance, and changes the first, second, and third compensation luminance signals having a luminance exceeding the threshold luminance into first, second, and third output luminance signals, wherein luminances of the first, second, and third output luminance signals are defined to be the threshold luminance. The three color de-gamma converter converts the first, second, and third output luminance signals into first, second, and third output gray signals. The white de-gamma converter that converts the white luminance signal into the white output image signal.

The RGBW converter may further include: a first signal ordering unit that arranges the first, second, and third input image signals in order of magnitude of the grays of the respective first, second, and third input image signals; and a second signal ordering unit that is formed between the clipping unit and the three color de-gamma converter and rearranges the first, second, and third input image signals in accordance with color.

According to another embodiment of the present invention, a driving method of a display device is provided that includes: receiving input image signals of three colors; converting the input image signals into four color output image signals; calculating a current consumption amount consumed in pixels using the output image signals; defining a current change constant from the current consumption amount; and determining the luminance compensation constant from the current consumption amount and a total number. The total number is defined by counting luminances exceeding a threshold luminance in the first, second, third, and white output image signals of one frame, changing magnitudes of the input image signals based on the current change constant to generate conversion image signals, and generating the output image signals from the conversion image signals based on the luminance compensation constant.

The calculation of the current consumption amount may include receiving the output image signals for first, second, third, and white colors, and calculating the current consumption amount.

The determination of the current change constant and the luminance compensation constant may include: determining whether the current consumption amount is included within a predetermined range; when the current consumption amount is included in the predetermined range, outputting a previous current change constant and a previous luminance compensation constant as a new current change constant and a new luminance compensation constant; when the current consumption amount is less than a lower limit of the predetermined range, determining that the current change constant has a maximum value; when the current change constant has the maximum value, defining a current luminance compensation constant by using an operation, and when the current change constant does not have the maximum value, increasing the current change constant by a compensation value ΔS to calculate the new current change constant; when the current consumption amount is larger than or equal to the lower limit of the predetermined range, determining that the luminance compensation constant has a minimum value; and when the luminance compensation constant has the minimum value, decreasing the current change constant by the compensation value ΔS to calculate the new current change constant, and when the luminance compensation constant does not have the minimum value, decreasing the luminance compensation constant by the compensation value ΔC to calculate the new luminance compensation constant.

The predetermined range of the current consumption amount may be about 10% to about 35% of a maximum current amount.

The luminance compensation constant may be defined based on the total number.

The respective compensation values ΔS and ΔC may be fixed or varied. The respective compensation values ΔS and ΔC may be fixed based on the number of bits of the output image signals.

The respective compensation values ΔS and ΔC may have a value of ½ the number of bits in the output image signals).

The current change constant may have an initial value of “1”, and the luminance compensation constant may have an initial value of “0”.

### BRIEF DESCRIPTION OF THE DRAWINGS

The present invention will become more apparent by describing preferred embodiments thereof in detail with reference to the accompanying drawings, in which:

FIG. 1 is a block diagram of an OLED according to an exemplary embodiment of the present invention;

FIG. 2 is an equivalent circuit diagram of a pixel of an OLED according to an exemplary embodiment of the present invention;

FIG. 3 shows pixel arrangements of an OLED according to an exemplary embodiment of the present invention;

FIG. 4 is a block diagram of a signal processor according to an exemplary embodiment of the present invention;

FIG. 5 is a block diagram of an RGBW converter according to an exemplary embodiment of the present invention;

FIG. 6 is a flow chart of an operation of the RGBW converter shown in FIG. 5; and

FIG. 7 is a flow chart of an operation of a constant determiner according to an exemplary embodiment of the present invention.

### DETAILED DESCRIPTION

The present invention will be described more fully hereinafter with reference to the accompanying drawings, in which exemplary embodiments of the present invention are shown. This invention may, however, be embodied in many different forms and should not be construed as limited to the exemplary embodiments set forth herein. In the drawings, the thickness of layers and regions are exaggerated for clarity. Like numerals refer to like elements throughout. It will be understood that when an element such as a layer, film, region, substrate, or panel is referred to as being “on” another element, it can be directly on the other element or intervening elements may also be present. In contrast, when an element is referred to as being “directly on” another element, there are no intervening elements present.

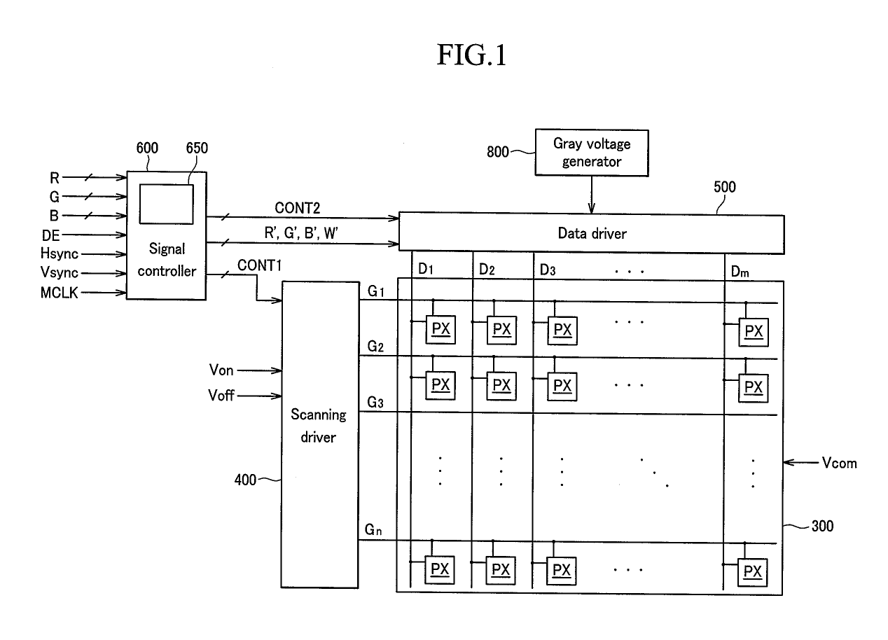

An OLED that is an example of display devices will be described with reference to FIGS. 1 to 3.

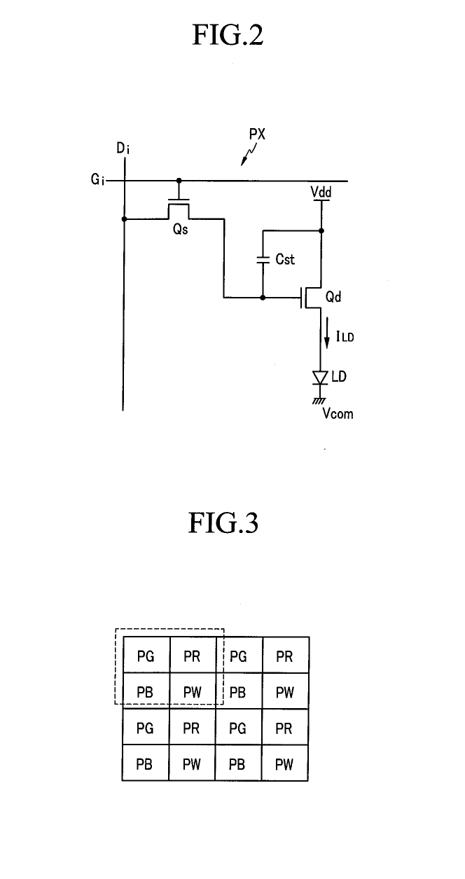

FIG. 1 is a block diagram of an OLED according to an exemplary embodiment of the present invention, FIG. 2 is an equivalent circuit diagram of a pixel of an OLED according to an exemplary embodiment of the present invention, and FIG. 3 shows pixel arrangements of an OLED according to an exemplary embodiment of the present invention.

Referring to FIG. 1, an OLED according to an exemplary embodiment includes a display panel 300, a scanning driver 400, a data driver 500 that are connected to the display panel 300, a gray voltage generator 800 coupled to the data driver 500, and a signal controller 600 that controls the above elements.

The display panel 300 includes a plurality of signal lines G₁-Gₙ and D₁-Dₘ, a plurality of voltage lines (not shown), and a plurality of pixels PX connected to the signal lines G₁-Gₙ and D₁-Dₘ and the voltage lines and arranged substantially in a matrix, in a circuital view shown in FIG. 2.

The signal lines G₁-Gₙ and D₁-Dₘ include a plurality of scanning lines G₁-Gₙ for transmitting scanning signals and a plurality of data lines D₁-Dₘ for transmitting data signals. The scanning lines G₁-Gₙ extend substantially in a row direction and substantially parallel to each other, while the data lines D₁-Dₘ extend substantially in a column direction and substantially parallel to each other.

Referring to FIG. 2, each of the pixels PX, for example, a pixel PX in an i-th row (i=1, 2, . . . , n) and a j-th column (j=1, 2, . . . , m), is connected to a scanning line Gᵢ and a data line Dⱼ and includes an organic light emitting element LD, a driving transistor Qd, a capacitor Cst, and a switching transistor Qs.

The switching transistor Qs, such as a thin film transistor (TFT), has three terminals, including a control terminal connected to the scanning line Gᵢ, an input terminal connected to the data line Dⱼ, and an output terminal connected to the driving transistor Qd. The switching transistor Qs transmits a data voltage in response to a scanning signal applied to the scanning line Gᵢ.

The driving transistor Qd, such as a TFT, also has three terminals, including a control terminal connected to the output terminal of the switching transistor Qs, an input terminal connected to a driving voltage Vdd, and an output terminal connected to the organic light emitting element LD. The driving transistor Qd flows an output current I_{LD}, having a magnitude defined based on a voltage, across the control terminal and the output terminal.

The capacitor Cst is connected between the control terminal and the input terminal of the driving transistor Qd. The capacitor Cst charges the data voltage applied to the control terminal of the driving transistor Qd through the switching transistor Qs and maintains the data voltage after the switching transistor Qs is turned off.

The organic light-emitting element LD may be an organic light emitting diode, and the organic light-emitting element LD has an anode connected to the output terminal of the driving transistor Qd and a cathode connected to a common voltage Vcom. The organic light emitting element LD emits light having an intensity depending on the output current ILD of the driving transistor Qd. The organic light emitting element LD uniquely represents one of the primary colors and a white color. An example of a set of the primary colors includes red, green, and blue, and a spatial sum of the primary colors represents a desired color. By adding white light to the synthesized light, the total luminance of the color increases.

Alternatively, the organic light emitting elements LD of all pixels PX may emit white light. In this case, some pixels PX may further include a color filter (not shown) that changes white light emitting from the organic light-emitting element LD to one of the primary color lights.

Referring to FIG. 3, the pixels PX for emitting lights of red, green, blue, and white are referred to as a red pixel PR, a green pixel PG, a blue pixel PB, and a white pixel PW, respectively, and are arranged in a 2×2 matrix. When a pixel set that is arranged in this way is referred to as a “dot”, the OLED has a structure in which the dots are repeatedly disposed in a row direction and a column direction.

In each dot, the red pixel PR is opposite to the blue pixel PB in a diagonal direction, and the green pixel PG is opposite to the white pixel PW in a diagonal direction. In one dot, it is most preferable to have a structure in which a green pixel PG and a white pixel PW face each other in the diagonal direction with respect to a color characteristic of the OLED.

However, the four-color pixels PR, PG, PB, and PW may have a stripe arrangement or a pentile arrangement in addition to the checked arrangement of FIG. 3.

The switching transistor Qs and the driving transistor Qd are n-channel field effect transistors (FETs) including amorphous silicon or polysilicon. However, at least one of the transistors Qs and Qd may be a p-channel FET operating in a manner opposite to n-channel FETs. In addition, the connections of the transistors Qs and Qd, the capacitor Cst, and the OLED LD may be varied.

Referring to FIG. 1 again, the scanning driver 400 is connected to the scanning lines G₁-Gₙ of the display panel 300, and synthesizes a high voltage Von for turning on the switching transistors Qs and a low voltage Voff for turning off the switching transistors Qs to generate scanning signals for application to the scanning lines G₁-Gₙ.

The data driver 500 is connected to the data lines D₁-Dₘ of the display panel 300 and applies data voltages to the data lines D₁-Dₘ.

The gray voltage generator 800 generates a plurality of gray voltage sets to output to the data driver 500. The gray voltage sets may be different for each color considering light emitting efficiency and lifetime of a light emitting material.

The signal controller 600 controls the scanning driver 400, the data driver 500, etc.

Further, the signal controller 600 includes a signal processor 950 that generates four-color output image signals R′, G′, B′, and W′ from three color input image signals R, G, and B. The signal processor 950 will be described in detail later.

Each of the units 400, 500, 600, and 800 may include at least one integrated circuit (IC) chip mounted on the LC panel assembly 300 or on a flexible printed circuit (FPC) film as a tape carrier package (TCP) type, which are attached to the panel assembly 300. Alternatively, at least one of the units 400, 500, 600, and 800 may be integrated with the display panel 300 along with the signal lines G₁-Gₙ, D₁-Dₘ and the transistors Qs and Qd. As a further alternative, all the units 400, 500, 600, and 800 may be integrated into a single IC chip, but at least one of the units 400, 500, 600, and 800 or at least one circuit element of at least one of the units 400, 500, 600, and 800 may be disposed outside of the single IC chip.

An operation of the organic light-emitting device will now be described.

The signal controller 600 is supplied with the input image signals R, G, and B of three colors such as red, green, and blue, and input control signals for controlling the display thereof from an external graphics controller (not shown). The input image signals R, G, and B are digital signals having a value (gray) corresponding to the luminance of each pixel PX. The number of grays may be, for example 1024 (=2¹⁰), 256 (=2⁸), or 64 (=2⁶). A luminance represented by each gray is defined by a gamma curve of the display device, and converting the input image signals R, G, and B or the grays to luminances is called “a gamma conversion”.

The input control signals include a vertical synchronization signal Vsync, a horizontal synchronization signal Hsync, a main clock signal MCLK, a data enable signal DE, etc.

The signal controller 600 converts the three-color input image signals R, G, and B into one white output image signal W′ and three color output image signals R′, G, and B′. The signal controller 600 also determines a current amount consumed in the display panel 300 using the output image signals R′, G′, B′, and W′, and adjusts magnitudes of the output image signals R′, G′, B′, and W′.

The signal controller 600 also generates scanning control signals CONT1 and data control signals CONT2, and then transmits the scanning control signals CONT1 to the scanning driver 400 and the data control signals CONT2 and the processed output image signals R′, G′, B′, and W′ to the data driver 500.

The scanning control signals CONT1 include a scanning start signal STV for instructing to start scanning and at least one clock signal for controlling the output time of the high voltage Von. The scanning control signals CONT1 may further include an output enable signal OE for defining the duration of the high voltage Von.

The data control signals CONT2 include a horizontal synchronization start signal STH for informing of start of transmission of the output image signals R′, G′, B′, and W′ for a row of pixels PX, a load signal LOAD for instructing to apply the data voltages to the data lines D₁-Dₘ, and a data clock signal HCLK.

In response to the data control signals CONT2 from the signal controller 600, the data driver 500 receives a packet of the output image signals R′, G′, B′, and W′ for the row of pixels PX and converts the digital output image signals R′, G′, B′, and W′ into analog data voltages.

The scanning driver 400 applies the high voltage Von to a scanning line G₁-Gₙ in response to the gate control signals CONT1 from the signal controller 600, thereby turning on the switching transistors Qs connected to the scanning lines G₁-Gₙ.

Accordingly, the switching transistors Qs of the corresponding pixel row are turned on, and the driving transistors Qd receive the corresponding data voltages through the turned-on switching transistors Qs. Each driving transistor Qd outputs a driving current I_{LD} corresponding to the applied data voltage to the organic light-emitting element LD. Accordingly, the organic light-emitting element LD emits light of a magnitude corresponding to the driving current I_{LD}.

By repeating the process for each unit of a horizontal period (which is also referred to as “1H”, and which is equal to one period of a horizontal synchronizing signal Hsync and a data enable signal DE), all of the scanning lines G₁-Gₙ are sequentially supplied with the high voltage Von, thereby applying the voltages to all pixels PX to display one frame of the image.

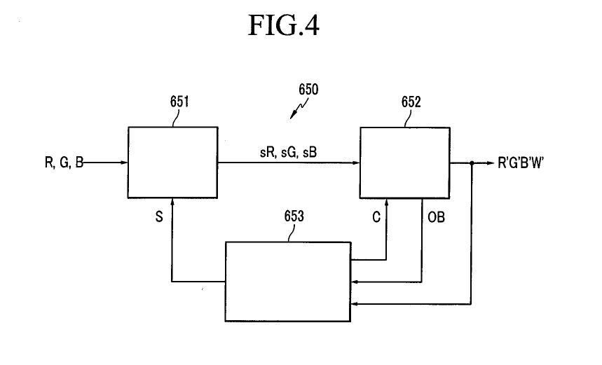

Next, referring to FIG. 4, the signal processor 950 according to an exemplary embodiment of the present invention will be described.

FIG. 4 is a block diagram of a signal processor according to an exemplary embodiment of the present invention.

The OLED according to an exemplary embodiment of the present invention includes the signal controller 600 having a signal processor 950, as described above.

Referring to FIG. 4, the signal processor 950 includes a scaling unit 651, an RGBW converter 652, and a constant determiner 653.

The scaling unit 651 is supplied with three color input image signals R, G, and B from an external device and converts the three color input image signals R, G, and B into three color conversion image signals sR, sG, and sB. The three color-conversion image signals sR, sG, and sB are obtained to change magnitudes of the input image signals R, G, and B based on a current change constant S. In this embodiment, the three color-conversion image signals sR, sG, and sB are defined as values obtained by multiplying the input image signals R, G, and B by the current change constant S, respectively. As described, the input image signals R, G, and B are respectively converted into the three color-conversion image signals sR, sG, and sB based on the current change constant S. However, alternatively, the input image signals R, G, and B may be converted into the three color-conversion image signals sR, sG, and sB using a predetermined function. The current change constant S may have a value between more than “0” and less than or equal to “1”.

The RGBW converter 652 converts the three color-conversion image signals sR, sG, and sB from the scaling unit 651 into one white output image signal W and three color output image signals R′, G′, and B′. At this time, for example, the RGBW converter 652 may define the smallest luminance of the three conversions image signals sR, sG, and sB as a luminance of the white output image signal W′. Based on the above manner using the smallest luminance, various embodiments for converting three conversion image signal sR, sG, and sB into four color output image signals R′, G′, B′, and W′ may be applicable.

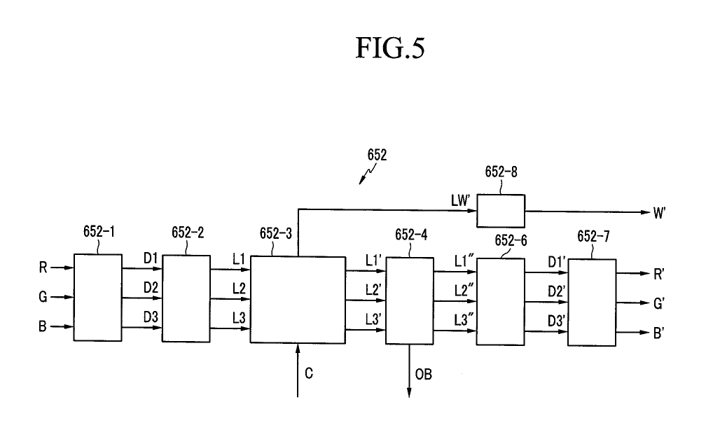

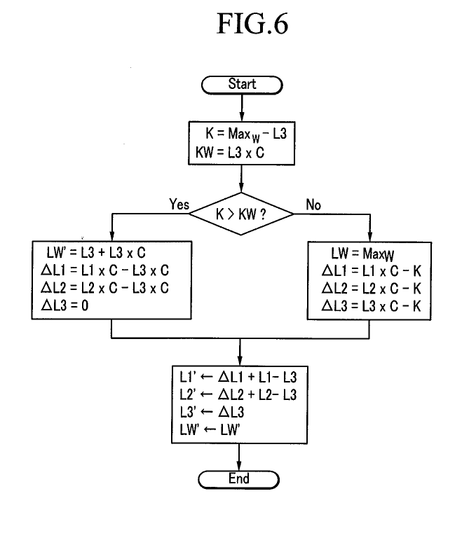

Next, an operation of the RGBW converter according to one embodiment of the various embodiments will be described with reference to FIGS. 5 and 6.

FIG. 5 is a block diagram of an RGBW converter according to an exemplary embodiment of the present invention, and FIG. 6 is a flow chart of an operation of the RGBW converter shown in FIG. 5.

Referring to FIG. 5, the RGBW converter 652 includes a first signal ordering unit 652-1, a gamma converter 652-2, a calculator 652-3, a clipping unit 652-4, a three color de-gamma converter 652-6, a second signal ordering unit 652-7, and a white de-gamma converter 652-8.

The first signal ordering unit 651 is supplied with the plurality of groups of three color conversion image signals sR, sG, and sB and arranges the three color conversion image signals sR, sG, and sB included in each group of three color conversion image signals sR, sG, and sB based on grays thereof. The arrangement order may be in the order of magnitude of the grays of the respective conversion image signals sR, sG, and sB. For example, the three color-conversion image signals sR, sG, and sB may be arranged in descending power of the grays.

When the three color-conversion image signals sR, sG, and sB are arranged in descending power of the grays, it is assumed that a first signal D1, a second signal D2, and a third signal D3 are sequentially defined from the input image signal R, G, and B of the largest gray to the input image signal R, G, and B of the smallest gray of the three color input image signals R, G, and B. In addition, grays of the first, second, and third signals D1, D2, and D3 are sequentially referred to as a first gray, a second gray, and a third gray.

The gamma converter 652-2 gamma-converts the first to third signals D1, D2, and D3 to generate first to third luminance signals L1, L2, and L3, respectively. The luminance signals L1, L2, and L3 have a first luminance, a second luminance, and a third luminance corresponding to the first to third grays, respectively.

The calculator 652-3 generates a white luminance signal LW′ based on the first to third luminance signals L1, L2, and L3 and a luminance compensation constant C input from the constant determiner 653 and converts the first to third luminance signals L1, L2, and L3 to first to third compensation luminance signals L1′, L2′, and L3′, respectively.

Referring to FIG. 6, an operation of the calculator 652-3 for generating the white luminance signal LW′ and the first to third compensation luminance signals L1′, L2′, and L3′ will be described.

The calculator 652-3 may define the third luminance signal L3 of the three luminance signals L1, L2, and L3, which has the smallest gray, as a white initial signal LWᵢₙᵢ, and may define first to third initial luminance signals L1ᵢₙᵢ, L2ᵢₙᵢ, and L3ᵢₙᵢ by subtracting the gray of the white initial signal LWᵢₙᵢ from the first to third luminance signals L1-L3, respectively. Thereby, the first initial luminance signal L1ᵢₙᵢ may have a value obtained by subtracting the third luminance from the first luminance, the second initial luminance signal L2ᵢₙᵢ may have a value obtained by subtracting the third luminance from the second luminance, and the third initial luminance signal L3ᵢₙᵢ may be 0.

In addition, the calculator 652-3 receives the luminance compensation constant C from the constant determiner 653 and multiplies the first to third luminance signals L1, L2, and L3 by the luminance compensation constant C, respectively, to define first to third initial luminance compensation values ΔL1ᵢₙᵢ, ΔL2ᵢₙᵢ, and ΔL3ᵢₙᵢ.

Therefore, the first to third initial luminance compensation values ΔL1ᵢₙᵢ, ΔL2ᵢₙᵢ, and ΔL3ᵢₙᵢ satisfy Equation 1 below.

ΔL1ini=L1×C, ΔL2ini=L2×C, ΔL3ini=L3×C [Equation 1]

Next, the calculator 652-3 generates the white luminance signal LW′ and the first to third compensation luminance signals L1′, L2′, and L3′ in accordance with operations of the flowchart shown in FIG. 6.

Thereby, a white light amount of luminances generated by the first to third initial luminance compensation values ΔL1ᵢₙᵢ, ΔL2ᵢₙᵢ, and ΔL3ᵢₙᵢ is the same as the third initial luminance compensation value ΔL3ᵢₙᵢ that is the minimum of the initial luminance compensation values ΔL1ᵢₙᵢ, ΔL2ᵢₙᵢ, and ΔL3ᵢₙᵢ, and hereinafter the white light amount is referred to as a white luminance increment KW.

The maximum luminance represented by the white pixel PW is called the white maximum luminance Max_{w}. Since the white initial signal LWᵢₙᵢ has a luminance (referred to as ‘a third luminance’) of the third luminance signal L3, the white pixel PW has a white luminance margin amount K corresponding to a difference between the white maximum luminance Max_{w} and the third luminance signal L3, compared to the luminance of the white initial signal LWᵢₙᵢ.

The calculator 652-3 compares the white luminance increment KW and the white luminance margin amount K, and generates the white luminance signal LW′ and the first to third compensation luminance signals L1′-L3′ based on the comparison result.

When the white luminance margin amount K is larger than the white luminance increment KW, the calculator 652-3 operates the white luminance signal LW′ by adding the white initial signal LWᵢₙᵢ and the white luminance increment KW. The calculator 652-3 also defines differences between the first to third initial luminance compensation values ΔL1ᵢₙᵢ, ΔL2ᵢₙᵢ, and L3ᵢₙᵢ and the white luminance increment S as first to third luminance compensation values ΔL1, ΔL2, and ΔL3, respectively.

Thus, the first to third luminance compensation values ΔL1, ΔL2, and ΔL3 satisfy Equation 2 below.

ΔL1=ΔL1ini−KW, ΔL2=ΔL2ini−KW, ΔL3=ΔL3ini−KW [Equation 2]

The third luminance compensation value ΔL3 is about 0.

When the white luminance margin amount K is equal to or less than the white luminance increment KW, the calculator 652-3 defines the white maximum luminance Max_{w} as a luminance of the white luminance signal LW′, and operates the first to third luminance compensation values ΔL1, ΔL2, and ΔL3 to satisfy Equation 3.

ΔL1=ΔL1ini−K, ΔL2=ΔL2ini−K, ΔL3=ΔL3ini−K [Equation 3]

That is, when the white luminance increment KW is larger than the white luminance margin amount K, the white luminance increment KW is divided into white light represented by combination of the red, green, and blue pixels PR, PG, and PB and white light of the white pixel PW.

Thereby, when white light corresponding to the white luminance increment KW is represented, currents flowing through the red, green, and blue pixels PR, PG, and PB are minimized to reduce consumption power of the red, green, and blue pixels PR, PG, and PB.

The calculator 652-3 adds the first to third luminance compensation values ΔL1, ΔL2, and ΔL3 of Equation 2 or Equation 3 to the first to third initial luminance signals L1ᵢₙᵢ, L2ᵢₙᵢ, and L3ᵢₙᵢ to define the first to third compensation luminance signals L1′, L2′, and L3′, respectively. In addition, the calculator 653 adds the white luminance compensation values ΔLW to the white initial luminance signals LWᵢₙᵢ to define the white luminance signal LW1′.

That is, the first to third compensation luminance signals L1′-L3′ and the white luminance signal LW′satisfy Equation 4 below.

Li′=Li+LWini+(Li×C−ΔW), (i=1, 2, 3),

LW′=LWini+ΔW, [Equation 4]

ΔW has the minimum value between the first to third initial luminance compensation values ΔL1ᵢₙᵢ, ΔL2ᵢₙᵢ, and ΔL3ᵢₙᵢ, and the white luminance margin amount K.

The calculator 652-3 outputs the first to third compensation luminance signals L1′, L2′, and L3′ to the clipping unit 652-4, and outputs the white luminance signal LW′ to the white de-gamma converter 652-8.

Referring to FIG. 5 again, the clipping unit 652-4 receives the first to third compensation luminance signals L1′-L3′ from the calculator 652-3, and compares luminances of the compensation luminance signals L1′-L3′ and a threshold luminance (not shown), respectively.

When there is a compensation luminance signal having a luminance more than the threshold luminance, the clipping unit 654 changes the luminance of the compensation luminance signal to the threshold luminance to generate the first to third output luminance signals L1″, L2″, and L3″.

The threshold luminance may be defined as the minimum value of the maximum luminance of each of the red, green, and blue pixels PR, PG, and PB. Alternatively, a plurality of threshold luminances having different values with respect to each color may be used.

When the luminance of the first, second, or third compensation luminance signal L1′, L2′, or L3′ is more than the threshold luminance, the clipping unit 652-4 counts the number having the luminance more than the threshold luminance for one frame to generate a counted signal OB. The signal OB is applied to the constant determiner 653. That is, the signal OB is the total number of image signals R, G, and B having a luminance larger than the threshold luminance in image signals R, G, and B of one frame. The constant determiner 653 determines the luminance compensation constant C on the basis of the counted signal OB.

The three color de-gamma converter 652-6 de-gamma converts the first to third output luminance signals L1″, L2″, and L3″ received from the clipping unit 652-4 using a gamma function to generate the first to third output gray signals D1′, D2′, and D3′.

The second signal ordering unit 652-7 rearranges the first to third output gray signals D1′-D3′ in accordance with color information, that is, color, and defines the rearranged output gray signals D1′-D3′ as three color output image signals R′, G′, and B′ of the red, green, and blue colors, respectively. At this time, the rearrangement order of the output gray signals D1′-D3′ is red, green, and blue, but it may be varied.

The three color de-gamma converter 652-6 may perform the de-gamma conversion using a plurality of gamma functions that are different for each color, instead of one gamma function. In this case, the three-color de-gamma converter 656 rearranges the first to third output luminance signals L1″-L3″ in accordance with the color information, and de-gamma converts them based on the gamma functions that are respectively defined with respect to the respective color to generate the three color output image signals R′, G′, and B′.

The white de-gamma converter 652-8 de-gamma converts the white luminance signal LW to generate the white output image signal W′.

The RGBW converter 652 outputs the three-color output image signals R′, G′, and B′ and the white output image signal W′ to the data driver 500.

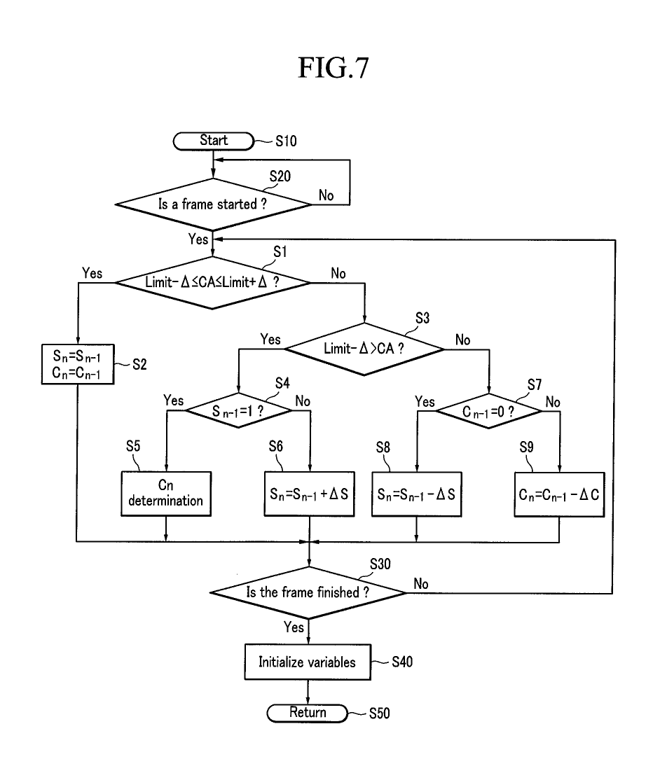

Next, an operation of the constant determiner 653 for determining the current change constant S and the luminance compensation constant C that form the basis of the operation of the scaling unit 651 and the RGBW converter 652 will be described with reference to FIG. 7.

FIG. 7 is a flow chart of an operation of a constant determiner according to an exemplary embodiment of the present invention. When an operation of the constant determiner 653 starts (S10), the constant determiner 653 determines whether a current frame is started (S20).

When the new frame is not started, the constant determiner 653 checks the start of the new frame.

However, when a new frame is started, the constant determiner 653 starts operations for determining a current change constant Sn and a luminance compensation constant Cn of a current frame.

Thus, first, the constant determiner 653 is supplied with the counted signal OB from the RGBW converter 652 and the output image signals R′, G′, B′, and W′ from the RGBW converter 652.

In FIG. 7, the current change constant S is divided into reference characters Sn and Sn-1, and the luminance compensation constant C is divided into reference characters Cn and Cn-1. The reference characters Sn and Cn denote a current change constant and a luminance compensation constant in a current frame [an n-th frame], respectively, and the reference characters Sn-1 and Cn-1 denote a current change constant and a luminance compensation constant in a previous frame [an (n-1)-th frame], respectively.

The constant determiner 653 calculates a current consumption amount CA consumed in the display panel 300 for a previous frame using the output image signals R′, G′, B′, and W′ of the previous frame, and then determines whether the current consumption amount CA is in a predetermined range (S1). Since the predetermined range is determined by considering a tolerance limit Δ in a reference amount current Limit, the predetermined range is (Limit−Δ≦CA≦Limit+Δ). In this embodiment, the reference amount current Limit may be between about 15% and about 30% of the maximum current amount in this embodiment, and thereby, the predetermined range is (5%−Δ≦CA≦30%+Δ).

Thereby, the constant determiner 653 determines whether the current consumption amount CA is included in the predetermined range (5%−Δ≦CA≦30%+Δ). In this embodiment, the tolerance limit Δ may have a value of about 2% to about 5% of the maximum current amount, and thereby the reference amount current Limit may be between about 10% and about 35% (10%≦CA≦35%) of the maximum current amount.

When the current consumption amount CA has a value in the predetermined range, the constant determiner 653 outputs the current change constant Sn-1 and the luminance compensation constant Cn-1 of the previous frame to the scaling unit 651 and the RGBW converter 652 as a current change constant Sn and a luminance compensation constant Cn of the current frame, respectively (S2).

In this embodiment, an initial value of the current change constant S is set as “1”, and an initial value of the luminance compensation constant C is set as “0”. In addition, the current change constant S has a value in a range between more than 0 and less than or equal to 1 (0<S≦1), and the luminance compensation constant C has a value in a range between equal to or more than 0 and equal to or less than 1 (0≦C≦1). However, since each of the initial values of the current change constant S and the luminance compensation constant C is converged in a constant value within a few seconds, the initial values of the current change constant S and the luminance compensation constant C may have any one in the above ranges, respectively.

When a value of the current consumption amount CA is not in the predetermined range, the constant determiner 653 determines whether a value of the current consumption amount CA is less than a lower value (Limit−Δ) of the predetermined range.

When a value of the current consumption amount CA does not exceed the lower value (Limit−Δ), the constant determiner 653 increases a value of the current change constant S to increase the current consumption amount CA.

That is, the constant determiner 653 determines whether the current change constant Sn-1 of the previous frame has the maximum value “1” (S4). When the current change constant Sn-1 of the previous frame does not have the maximum value “1”, the constant determiner 653 increases a value of the current change constant Sn-1 of the previous by a compensation value ΔS. In the embodiment, the compensation value ΔS has a value of ½ the number of bits. The number of bits is the number of bits of the image signals. In particular, in this embodiment, the number of bits may be the number of bits of the output image signals R′, G′, B′, and W′.

For example, when the output image signals R′, G′, B′, and W′ have 8 bits, the compensation value ΔS is fixed as a value of ½⁸, that is, 1/256. However, alternatively, the compensation value ΔS may be varied regardless of the number of bits of the output image signals R′, G′, B′, W′. That is, the compensation value ΔS may be defined based on a predetermined function or a condition. In this case, the consumption current amount in the display panel 300 is quickly and exactly optimized by the current change constant S. As the compensation value ΔS become larger, the time to reach a target current amount is shortened, but human eyes may sense the luminance variation for each frame. In addition, when an image variation is larger than a predetermined amount for every frame, a value of the current change constant S is largely changed for every frame such that an image quality may decrease. Thereby, the compensation values ΔS may be varied in an appropriate value.

The increased current change constant Sn-1 and the luminance compensation constant Cn-1 of the previous frame are output to the scaling unit 651 and the RGBW converter 652 as the current change constant Sn and the luminance compensation constant Cn of the current frame, respectively,

However, when the current change constant Sn-1 of the previous frame has the maximum value, the constant determiner 653 goes to a step for determining the luminance compensation constant Cn of the current frame (S5). Since the current change constant Sn-1 of the previous frame has the maximum value, the constant determiner 653 does not increase a value of the current change constant Sn-1.

As described above, the constant determiner 653 determines a value of the luminance compensation constant Cn using the counted signal OB from the RGBW converter 652. That is, the constant determiner 653 determines the luminance compensation constant Cn of the current frame by using the counted signal OB indicating the total number counted in the previous frame. As the total number may become larger, the value of the luminance compensation constant Cn may decrease, whereas, as the total number may become smaller, a value of the luminance compensation constant Cn may increase. That is, a value of the luminance compensation constant C may be defined as a function of the total number, and the constant determiner 653 may include a lookup table storing values of the luminance compensation constant C with respect to the total number.

As described, when a value of the luminance compensation constant Cn is defined by using the total number of the previous frame, the defined luminance compensation constant Cn and the current change constant Sn-1 having the maximum value “1” are output to the RGBW converter 652 and the scaling unit 651 as the luminance compensation constant Cn and the current change constant Sn of the previous frame, respectively.

However, in the step S3, when a value of the current consumption amount CA is larger than or equal to the lower value (Limit−Δ), the constant determiner 653 determines whether the luminance compensation constant Cn-1 of the previous frame has the minimum value “0” (S7). When the luminance compensation constant Cn-1 does not have the minimum value “0” in the step S7, the constant determiner 653 reduces a value of the luminance compensation constant Cn-1 of the previous frame by a compensation value ΔC to define the luminance compensation constant Cn of the current frame (S9). In this embodiment, similar to the compensation value ΔS, the compensation value ΔC has a value of ½ the number of bits of the image signals. In particular, in this embodiment, the number of bits may be the number of bits of the output image signals R′, G′, B′, and W′.

For example, when the output image signals R′, G′, B′, and W′ have 8 bits, the compensation value ΔC is fixed as a value of ½⁸, that is, 1/256. However, alternatively, the compensation value ΔC may be varied regardless of the number of bits of the output image signals R′, G′, B′, and W′. That is, the compensation value ΔC may be defined based on a predetermined function or a condition, and thereby the luminance compensation constant C is quickly and exactly optimized.

Thereby, the defined luminance compensation constant Cn and the current change constant Sn-1 of the previous frame are output to the RGBW converter 652 and the scaling unit 651 as the luminance compensation constant Cn and the current change constant Sn of the current frame, respectively.

However, when the luminance compensation constant Cn-1 has the minimum value “0” in the step S7, the constant determiner 653 reduces a value of the current change constant Sn-1 of the previous frame by the compensation value ΔS (S8). The compensation value ΔS has a value of ½ the number of bits, as described in the step S6. Alternatively, the compensation value ΔS may have a different value from ½ the number of bits.

The defined current change constant Sn and the luminance compensation constant Cn-1 are output to the scaling unit 651 and the RGBW converter 652, respectively. The luminance compensation constant Cn-1 of the previous frame is output as the luminance compensation constant Cn of the current frame.

Operation of the steps S2, S5, S6, S8, and S9 is performed until the current frame is terminated (S30). When the current frame is terminated, all of the variables used in the constant determiner 653 are reset (S40). At this time, the current change constant S and the luminance compensation constant C are used for an operation of the next frame without initialization.

As the above description referring to FIGS. 4 to 7, the signal processor 650 determines a current consumption amount using the output image signals R′, G′, B′, and W′ of the previous frame, and then defines the current change constant Sn and the luminance compensation constant Cn of the current frame. Next, the signal processor 650 converts the three color image signals R, G, and B and extracts a white image signal W′ to generate output image signals R′, G′, B′, and W′ of the current frame.

Therefore, the current consumption amount of the display device is maintained in a constant range to reduce a power consumption amount. In addition, when the display device is an OLED, a generation amount of heat of the organic light emitting diodes of the OELD reduces to elongate a lifetime of the organic light emitting diodes. Furthermore, as the power consumption amount is maintained in an optimal state, a luminance of the white pixel is maximized to improve a luminance of the display device.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A display device comprising:
a plurality of pixels that represent a first color, a second color, a third color, and white;
a signal processor that converts input image signals (referred to as first, second, and third input image signals) respective to first, second, and third colors into output image signals (referred to as first, second, and third output image signals) respective to the first, second, and third colors plus an output image signal (referred to as a white output image signal) for the white color, calculates a current consumption amount consumed in the pixels based on the first, second, third, and white output image signals, and compensates the first, second, third, and white output image signals in accordance with the current consumption amount; and
a data driver that converts the white output image signal and the first to third output image signals into data voltages and supplies the data voltages to the pixels.

2. The display device of claim 1, wherein:
the signal processor comprises:
a scaling unit that changes a magnitude of the first, second, and third input image signals based on a current change constant to generate first, second, and third conversion image signals;
an RGBW converter that generates the first, second, third, and white output image signals from the first, second, and third conversion image signals based on a luminance compensation constant; and
a constant determiner that defines the current change constant from the current consumption amount and defines the luminance compensation constant from the current consumption amount and a total number defined by counting luminances of the first, second, third, and white output image signals exceeding a threshold in one frame.

3. The display device of claim 2, wherein the constant determiner determines whether the current consumption amount is within a predetermined range, and, when the current consumption amount is within the predetermined range, outputs a previous current change constant and a previous luminance compensation constant as a new current change constant and a new luminance compensation constant, and, when the current consumption amount is out of the predetermined range, changes at least one of the previous current change constant and the previous luminance compensation constant to output such as the new current change constant and the new luminance compensation constant.

4. The display device of claim 3, wherein the predetermined range of the current consumption amount is about 10% to about 35% of a maximum current amount.

5. The display device of claim 4, wherein the predetermined range of the current consumption amount is about 15% to about 30% of a maximum current amount.

6. The display device of claim 2, wherein the RGBW converter generates the white output image signal and the first, second, and third output image signals based on the first, second, and third input image signals and the luminance compensation constant.

7. The display device of claim 6, wherein the RGBW converter comprises:
a gamma converter that gamma-converts the generated first, second, and third input image signals to generate first, second, and third luminance signals, respectively;
a calculator that generates a white luminance signal using the luminance compensation constant and the first, second, and third luminance signals, and converts the first, second, and third luminance signals into first, second, and third compensation luminance signals L1′, L2′, and L3′, respectively;
a clipping unit that respectively compares the first, second, and third compensation luminance signals and the threshold luminance, and changes the first, second, and third compensation luminance signals having a luminance exceeding the threshold luminance into first, second, and third output luminance signals, wherein luminances of the first, second, and third output luminance signals are defined to be the threshold luminance;
a three color de-gamma converter that converts the first, second, and third output luminance signals into first, second, and third output gray signals; and
a white de-gamma converter that converts the white luminance signal into the white output image signal.

8. The display device of claim 7, wherein the RGBW converter further comprises:
a first signal ordering unit that arranges the first, second, and third input image signals in order of magnitude of the grays of the respective first, second, and third input image signals; and
a second signal ordering unit that is formed between the clipping unit and the three color de-gamma converter and rearranges the first, second, and third input image signals in accordance with color.

9. A driving method of a display device, the method comprising:
receiving input image signals of three colors;
converting the input image signals into four-color output image signals;
calculating a current consumption amount consumed in pixels using the output image signals;
defining a current change constant from the current consumption amount, and
determining the luminance compensation constant from the current consumption amount and the total number of luminances exceeding a threshold luminance in the first, second, third, and white output image signals of one frame;
changing magnitudes of the input image signals based on the current change constant to generate conversion image signals; and
generating the output image signals from the conversion image signals based on the luminance compensation constant.

10. The driving method of claim 9, wherein the calculation of the current consumption amount comprises receiving the output image signals for first, second, third, and white colors and calculating the current consumption amount.

11. The driving method of claim 10, wherein the determination of the current change constant and the luminance compensation constant comprises:
determining whether the current consumption amount is included within a predetermined range;
when the current consumption amount is included in the predetermined range, outputting a previous current change constant and a previous luminance compensation constant as a new current change constant and a new luminance compensation constant;
when the current consumption amount is less than a lower limit of the predetermined range, determining that the current change constant has a maximum value;
when the current change constant has the maximum value, defining a current luminance compensation constant by using an operation, and when the current change constant does not have the maximum value, increasing the current change constant by a compensation value ΔS to calculate a new current change constant;
when the current consumption amount is larger than or equal to the lower limit of the predetermined range, determining that the luminance compensation constant has a minimum value;
when the luminance compensation constant has the minimum value, decreasing the current change constant by the compensation value ΔS to calculate a new current change constant, and
when the luminance compensation constant does not have the minimum value, decreasing the luminance compensation constant by the compensation value ΔC to calculate a new luminance compensation constant.

12. The driving method of claim 11, wherein the predetermined range of the current consumption amount is about 10% to about 35% of a maximum current amount.

13. The driving method of claim 12, the luminance compensation constant is defined based on the total number.

14. The driving method of claim 12, wherein the respective compensation values ΔS and ΔC are fixed or varied.

15. The driving method of claim 14, wherein the respective compensation values ΔS and ΔC are fixed based on the number of bits of the output image signals.

16. The driving method of claim 15, wherein the respective compensation values ΔS and ΔC have a value of 2 the number of bits in the output image signals).

17. The driving method of claim 9, wherein the current change constant has an initial value of “1”, and the luminance compensation constant has an initial value of “0”.
